(19) United States
(12) Patent Application Publication
(10) Pub. No.: US 2003/0037590 A1
(43) Pub. Date: Feb. 27, 2003

(54) Method of self-testing a semiconductor chemical gas sensor including an embedded temperature sensor

(76) Inventor: Kevin C. Stark, Richmond Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/940,408

(22) Filed: Aug. 27, 2001

(51) Int. Cl. G01N 31/10

(52) U.S. Cl. 73/1.03; 73/1.06

(57) ABSTRACT

A method of self-testing a semiconductor chemical gas sensor comprises the steps of: applying power to a heating element; obtaining a measurement from a temperature sensing element; adjusting the power applied to the heating element until the obtained measurement from the temperature sensing element reaches a desired measurement; obtaining a measurement from a gas sensitive element when the desired measurement is reached; and comparing the obtained measurement from the gas sensitive element to a reference measurement. An alternate method comprises the steps of: applying power to the heating element; obtaining measurements from the gas sensitive element and the temperature sensing element; adjusting the power applied to the heating element to cause a change in the obtained measurement from the temperature sensing element and obtaining a change in measurement from the gas sensitive element; and determining if the obtained change in gas measurement is consistent with the change in temperature measurement. Both methods may be performed in air and/or at ambient temperature.

### BACKGROUND OF THE INVENTION

The present invention is related to semiconductor chemical gas sensors, in general, and more particularly, to a method of self-testing a semiconductor chemical gas sensor having an embedded temperature sensing element.

Semiconductor chemical gas sensors which include a gas sensitive element which is metal oxide based, like Tin Oxide (SnO₂), for example, operate on the principle that a reducing gas in the environment is adsorbed onto the surface of the gas sensitive element changing the conductivity of the metal oxide. Thus, the change in conductivity or resistance may be measured to determine the concentration of the reducing gas in the environment. Typical reducing gases in the environment include Hydrogen (H₂), Carbon Monoxide (CO) and Methane (CH₄). For example, in the presence of one or more of these reducing gases in the environment, a SnO₂ resistor will exhibit a change in conductivity or conversely, in resistance. An increase in environmental temperature, like from room or ambient temperature up to 300° C. and beyond, for example, increases the reaction rate of the metal based sensing element with the reducing gases in the environment. Accordingly, an increase in sensor temperature results in a faster sensor reaction time as well as a larger change in conductivity. Thus, operation of the SnO₂ sensor at increased temperatures will change the conductivity of the SnO₂ to a greater extent. Additionally, heating of the sensor will drive off moisture in the gas sensitive film which may otherwise adversely affect the accuracy of the measurements as well as decrease the sensor lifetime.

Current semiconductor chemical gas sensors include an integrated or on-chip heating element for increasing the temperature of the gas sensitive element to enhance its reaction rate to the reducing gas being monitored in situ. Generally, known heating elements comprise resistive material that generates heat in proportion to the product of the square of the current passing through the heating element and the resistance thereof. However, there is currently no known methods of testing these type sensors in situ for detection of degraded sensor operation as a result of contamination, instability or drift, for example. Therefore, it is desired to provide a mechanism and method of testing the reliability and integrity of the sensor in situ which will allow for an early detection of the aforementioned degradation in sensor operation without having to remove the sensor from its operating environment. The present invention comprises such a mechanism and method.

### SUMMARY OF THE INVENTION

In accordance with one aspect of the present invention, a method of self-testing a semiconductor chemical gas sensor including a heating element, a gas sensitive element and an embedded temperature sensing element comprises the steps of: applying power to the heating element; obtaining a measurement from the temperature sensing element; adjusting the power applied to the heating element until the obtained measurement from the temperature sensing element reaches a desired measurement; obtaining a measurement from the gas sensitive element when the desired measurement is reached; and comparing the obtained measurement from the gas sensitive element to a reference measurement.

In accordance with another aspect of the present invention, a method of self-testing a semiconductor chemical gas sensor including a heating element, a gas sensitive element and an embedded temperature sensing element comprises the steps of: applying power to the heating element; obtaining measurements from the gas sensitive element and the temperature sensing element; adjusting the power applied to the heating element to cause a change in the obtained measurement from the temperature sensing element; obtaining a change in measurement from the gas sensitive element caused by the power adjustment; and determining if the obtained change in measurement from the gas sensitive element is consistent with the change in the obtained measurement from the temperature sensing element.

In accordance with yet another aspect of the present invention, a method of operating a semiconductor chemical gas sensor including a heating element, a gas sensitive element and an embedded temperature sensing element comprises the steps of: calibrating the sensor for a plurality of predetermined gas concentrations at a plurality of predetermined environment temperatures to establish first reference data representative of a gas concentration vs. gas sensitive element measurement relationship for each predetermined environment temperature of said plurality and second reference data representative of a environment temperature vs. temperature sensing element measurement relationship; storing the first and second reference data in a memory; applying power to the heating element; obtaining a measurement from the temperature sensing element; obtaining a measurement from the gas sensitive element; and accessing the memory with the temperature sensing element and gas sensitive element measurements to determine a gas concentration based on the temperature sensing element and gas sensitive element measurements.

### BRIEF DESCRIPTION OF THE DRAWINGS

FIG. 1 is a cross-sectional illustration of a semiconductor chemical gas sensor suitable for being operated and self-tested in accordance with the principles of the present invention.

FIG. 2 is an isometric illustration of the semiconductor chemical gas sensor embodiment of FIG. 1.

FIG. 3 is a top view of an exemplary lay out for a heating element and a temperature sensing element suitable for use in the operation and self-test of the semiconductor sensor embodiment.

FIG. 4 is a top view of an exemplary lay out for electrically conductive material of a gas sensitive element suitable for use in the operation and self-test of the semiconductor sensor embodiment.

FIG. 5 is a graph illustrating an operational example of the sensor embodiment under varying environmental temperatures.

FIG. 6 is a block diagram schematic illustrating an embodiment of the semiconductor sensor coupled to power and measuring circuits for operation and self-test.

FIG. 7 is a graph illustrating a calibration example of the semiconductor sensor embodiment.

### DETAILED DESCRIPTION OF THE INVENTION

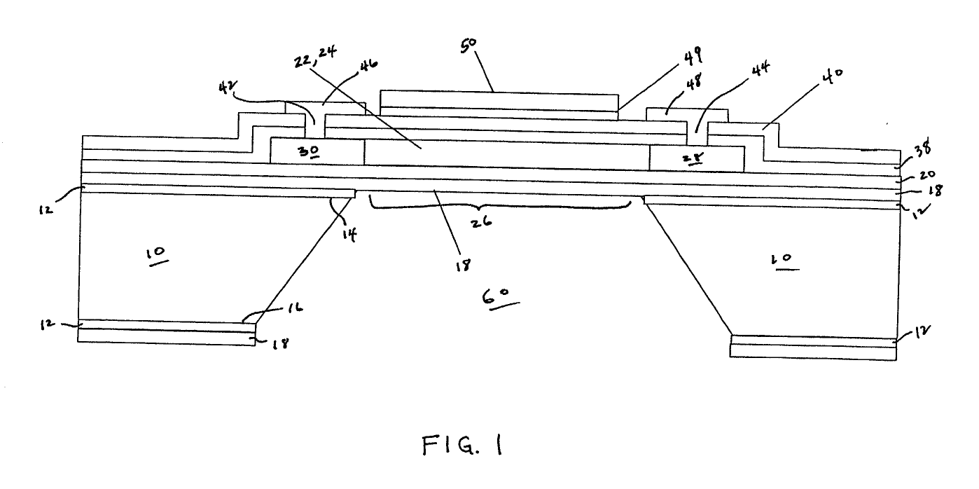

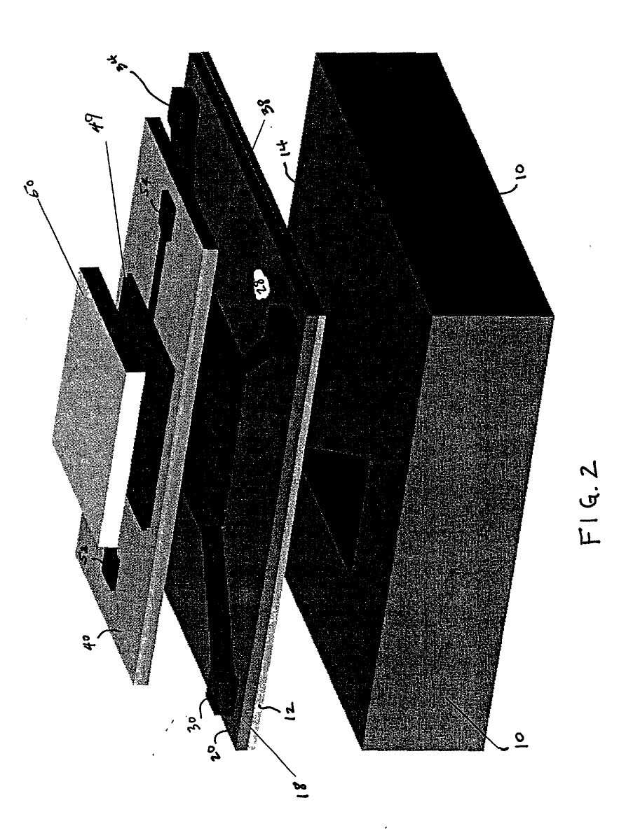

An exemplary semiconductor chemical gas sensor suitable for embodying one aspect of the present invention is illustrated in FIGS. 1-4. Referring to FIGS. 1-4, a substrate 10 of a material like Silicon, for example, may be dimensioned on the order of 5 millimeters by 5 millimeters square with a depth of approximately 550 micrometers. The substrate 10 may be just one die of many dies on the same Silicon wafer. An electrically isolating oxide layer 12, which may be Silicon dioxide, for example, is deposited by a conventional chemical vapor deposition process or grown via thermal oxidation on both of a front surface 14 and a back surface 16 of the substrate 10. In a similar manner, an additional electrically isolating layer 18, such as a nitride layer, which may be Silicon nitride, for example, is deposited over the oxide layers 12. Then, an additional oxide layer 20 is deposited over the nitride layer 18 using a similar process. In the present embodiment, the thickness of the oxide layers 12,20 and nitride layer 18 may be on the order of 0.2 micrometers and 0.15 micrometers, respectively.

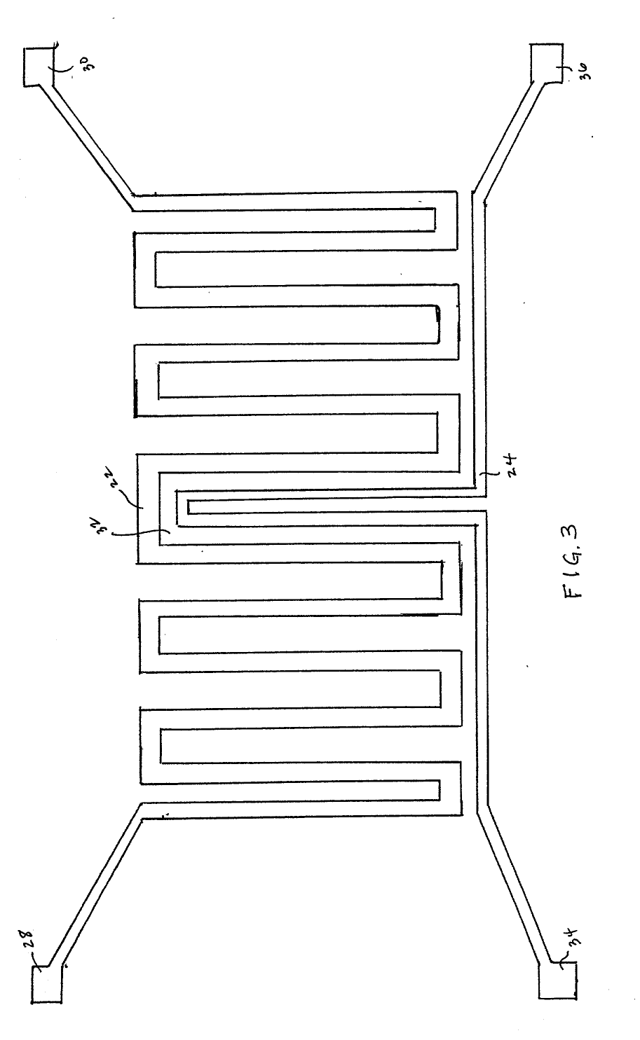

A heater element 22 and a temperature sensing element 24, both of a resistive material, like a polycrystalline silicon (herein after polysilicon), for example, may be deposited to a thickness of approximately one micrometer in proximate predetermined patterns over a predetermined area 26 of the oxide layer 20 using conventional photolithography techniques. The oxide and nitride layers 12, 18 and 20 isolate the elements 22 and 24 from the substrate 10. The elements 22 and 24 may be made of the same resistive material so that they may both be deposited and defined photolithographically and their patterns delineated in the same process steps. It is understood that this use of the same material for both of the elements 22 and 24 is merely for fabrication convenience and should not in any way be considered limiting to the present invention. The element 22 could just as well be formed of one material and the element 24 of another material without deviating from the broad principles of the present invention. In the present embodiment, the heater element 22 is deposited with a serpentine pattern over the predetermined area 26 as shown by the top view illustration thereof in FIG. 3 in order to effect a greater length. Since the resistance of the material 22 is proportional to the length thereof, the greater the length for a given width and film thickness, the greater the resistance. The pattern of element 22 extends out to contact regions 28 and 30. Also, as illustrated in FIG. 3, the temperature sensing element 24 may be juxtaposed with a portion 32 of the serpentine pattern of the element 22 and extends out to contact regions 34 and 36. The resistance of element 24 is also proportional to its length for a given width and film thickness. Thus, by increasing its length, its resistance may also be increased. Note that elements 22 and 24 are isolated electrically from each other by the oxide layer 20 and air, i.e. the spaces between the patterns.

An intermediate oxide layer may be deposited over the front of the semiconductor sensor covering the elements 22 and 24 including their respective contact regions using the same or similar conventional chemical vapor deposition process as used for depositing layers 12,18 and 20. To enhance the conductivity of the regions 22 and 24 and their respective contact regions, the intermediate oxide layer is opened over the regions 22 and 24 including their contact regions 28, 30, 34 and 36 for diffusion or implantation of such regions with a dopant material like Phosphorus or Boron, for example, using any of the well known fabrication processes wherein the unopended intermediate oxide layer acts as a doping mask for the patterns of regions 22 and 24. The depth of penetration of the ion implantation and thus, the conductivity of the regions may be controlled by the dosage of the Phosphorus or Boron ions and the energy by which they are projected to the regions 22 and 24. In the present embodiment, the heater region 22 including its contact regions 28 and 30 and the contact regions 34 and 36 of the temperature sensing element 24 are ion implanted with a high dosage of Boron and the region 24 absent its contact regions 34 and 36 is ion implanted with a lower dosage of Boron to render one region of polysilicon more conductive than the other.

After the aforementioned polysilicon regions 22 and 24 have been doped, the intermediate oxide layer is removed by stripping or etching away, for example, and electrical insulating passivation oxide and nitride layers 38 and 40 are deposited over the surface of the sensor covering elements 22 and 24. Holes or windows are opened through the layers 38 and 40 over the contact regions 28, 30, 34 and 36 and centered there about. These windows which are shown by way of example at 42 and 44 in the cross-sectional illustration of FIG. 1 are smaller in diameter than the contact regions over which they are opened. These smaller windows along with a photoresist layer form mask patterns for depositing metal contacts at the contact regions, like that shown at 46 and 48 for making contact with regions 30 and 28, for example. Like metal contacts are also deposited at contact regions 34 and 36 for making contact therewith. In the present embodiment, a conventional sputtering process is used for depositing Aluminum over the photoresist layer and through the masked window patterns to form the metal contact pads for the contact regions of the elements 22 and 24. The excess Aluminum is lifted off and washed away with the photoresist layer. If another metal is selected for the contact pads, a fabrication step or steps other than sputtering may be used for depositing the metal onto the contact regions.

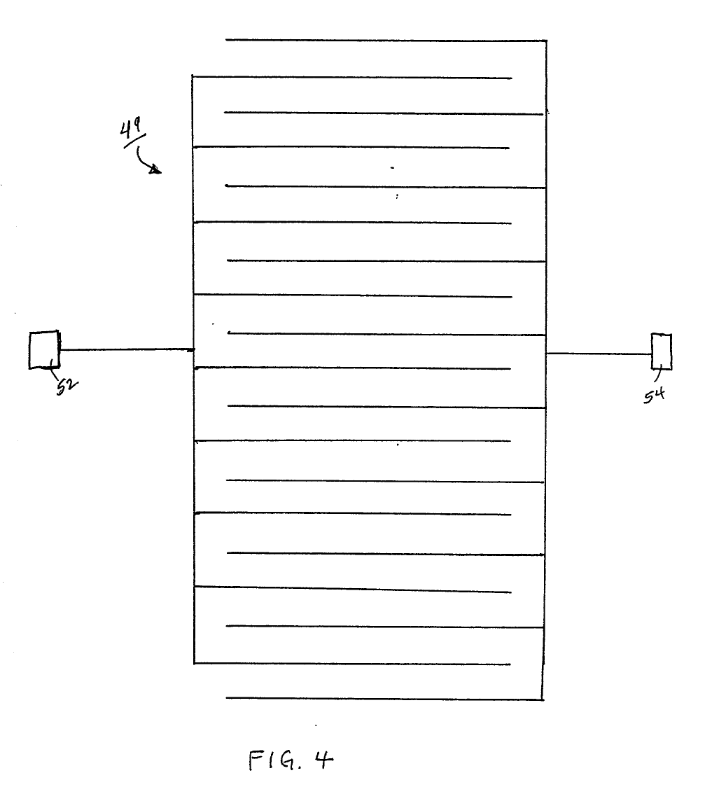

A gas sensitive element comprising patterns of conductive material 49 and a conductive gas sensitive material 50 is disposed in proximity to the heater and temperature sensing elements 22 and 24, respectively. In the present embodiment, the conductive material 49 may be deposited on the nitride layer 40 centered over the area of the heater element 22 in the form of first and second patterns disposed in close proximity to and electrically isolated from each other. The first and second patterns may take the form of interdigitated fingers interleaved together as shown in the top view illustration of FIG. 4, for example. Further in the present embodiment, the conductive patterns of 49 may comprise Platinum material which may be deposited on the nitride layer 40 using conventional sputtering fabrication techniques to a thickness of approximately 0.2 micrometers, for example. Each pattern extends out to form corresponding electrical contact regions 52 and 54. The gas sensitive material 50 which may be tin oxide (SnO₂) in the form of sol-gel, for example, which is a gel-like substance, may be spin coated over the front surface of the sensor. A conventional photolithography process may be used to remove the sol-gel layer from areas not intended to be covered leaving the patterns of conductive material 49 covered with the sol-gel material 50 to form electrically conductive paths or couplings across the first and second patterns 49. The conductivity or resistivity of these paths changes in response to the exposure of the layer 50 to gas concentrations in the environment. The remaining sol-gel layer 50 may be then baked in a furnace/oven at an elevated temperature to drive off any moisture present and convert the gel-like substance into a hardened solid layer of tin-oxide.

The graph of FIG. 5 illustrates by way of example using a family of curves the change in resistance of the gas sensitive element 49,50 by voltage measurement resulting from a change in gas concentration and temperature. For example, at room or ambient temperature T3, a gas concentration GC shown by the dashed line effects a voltage measurement V3 across the contacts 52 and 54 of the gas sensitive element 49,50. As the concentration of the gas increases the conductivity of the tin-oxide layer 50 will increase causing a decrease in resistance, and thus, a decrease in the voltage measurement, presuming a fixed current source. As the temperature increases from T3 to T2, the conductivity of the tin-oxide layer 50 will increase effecting a decrease in resistance and voltage measurement from V3 to V2 at the same concentration CG. Likewise, as the temperature is increased from T2 to T1, the resistance of layer 50 decreases even further causing the voltage measurement to fall from V2 to V1. Thus, if the sensor is operating properly, at a substantially constant gas concentration GC, for example, the voltage measurement will drop in proportion to an increase in temperature. This temperature/voltage change effect will occur even if the sensor is operating in pure air, i.e. primarily an Oxygen environment.

It is well known that the Silicon substrate 10 is a good conductor of heat. Thus having the heater element 22 fabricated over the substrate 10 at area 26, for example, will result in substantial heat losses through the Silicon under area 26. Consequently, a large amount of power may be applied to the heating element 22 to overcome the heat losses through the Silicon and maintain the sensor at a predetermined temperature, and in fact, the rate of heat loss through the Silicon may altogether prevent attainment of the desired temperature, regardless of the power applied. In order to mitigate these heat losses and effectively reduce power in the present embodiment, a portion 60 of the Silicon substrate 10 under the predetermined area 26 may be etched away by a conventional photolithography process and a KOH etch, for example, to open up the substrate 10 to air which is not a good conductor of heat. This opening 60 may be on the order of several hundred micrometers square for the present embodiment. The Nitride layer 18 may be used as an etch stop for the etching process because its etch rate is much slower than that of Silicon and Silicon dioxide. The etching rate through the Silicon substrate 10 by the KOH will cause sloped sides which form the opening 60. With the opening 60, some of the heat from the heating element 22 will still be dissipated laterally through the layers 12, 18 and 20, but this heat loss will be of a substantially lower magnitude of heat than that lost to the bulk Silicon directly beneath the area 26 over which the heating element is disposed. Accordingly, the opening 60 in the substrate will provide for a more efficient operational semiconductor sensor.

As indicated above, many of the foregoing described semiconductor sensors may be fabricated on a common Silicon wafer. After fabrication, each sensor die which may be on the order of 5 mm by 5 mm, for example, may be diced from the wafer and disposed in a package like a TO-16 can, for example. The die pads 28, 30, 34, 36, 52 and 54 among others may be wire bonded to corresponding pads of the can package using conventional wire bonding techniques. The top of the can package may have a meshed opening to permit contact of the gas sensitive element 49,50 with the environment being monitored thereby. One or more of the can packages containing the semiconductor sensors may be disposed in situ at positions in the environment to monitor the overall gas concentrations of the environment. Power and measuring circuits may be coupled to the semiconductor sensors through the leads of its can package as shown by the block diagram schematic illustration of FIG. 6. While for the present example, the measuring circuits are depicted as being external to the can package of the semiconductor sensor, it is understood that these circuits may also be disposed within the can package or even on the same substrate as the sensor without deviating from the principles of the present invention.

Referring to FIG. 6, the leads of the can package 62 bonded to the contacts 28 and 30 of the heating element 22 are coupled to an adjustable power source 64. Similarly, the leads of the package 62 bonded to the contacts 34 and 36 of the temperature measuring element 24 are coupled to a current source 66 and an amplifier circuit 68. Further, the leads of the package 62 bonded to the contacts 52 and 54 of the gas sensitive element 49,50 are coupled to a current source 70 and an amplifier circuit 72. In operation, power is applied to the heater element 22 via power source 64 to heat the gas sensitive element 49,50 of the sensor to a desired temperature. A fixed current is conducted through the temperature sensing element 24 by current source 66 and the voltage across the resistive material thereof which is representative of the temperature of the sensor is measured by the amplifier 68 and provided over signal line 74, for example. Power source 64 may be adjusted until the voltage at 74 is representative of the desired sensor temperature. The sensor may be maintained at this desired temperature for a period of time until it is considered to have reached an equilibrium state. Then, a fixed current is conducted through the gas sensitive element 49,50 by the current source 70 and the voltage across the resistive material thereof which is representative of gas concentration of the environment is measured by the amplifier circuit 72 and provided over signal 76, for example.

This voltage measurement at 76 will change in response to varying gas concentrations and environmental temperatures. So, it is desirable to calibrate each sensor for various gas concentrations and environment temperatures. During the calibration procedure, measurements 76 of gas concentrations and measurements 74 of temperatures are taken at predetermined gas concentrations and environment temperatures to establish relationships between gas concentration and gas concentration measurements 76 and between environment temperature and temperature measurements 74, for example. The measurements taken during calibration are stored in a memory, preferably in the form of a look-up table. Accordingly, in operation of the gas sensor, the effective measured gas concentration may be accessed from the reference data or table in memory using the obtained temperature measurements 74 and gas concentration measurements 76.

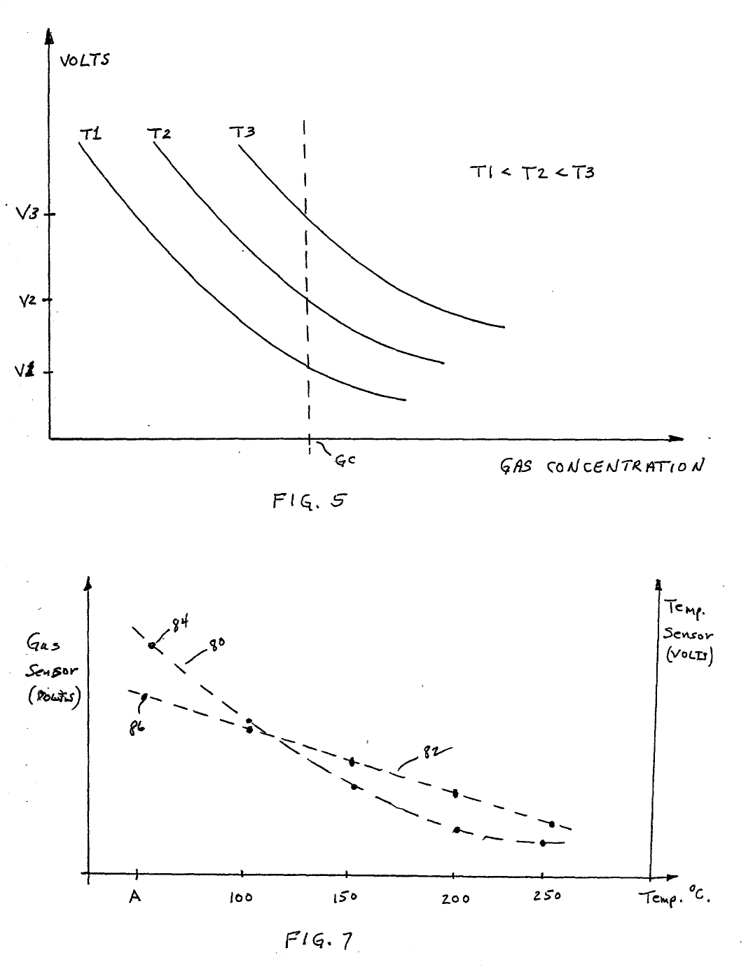

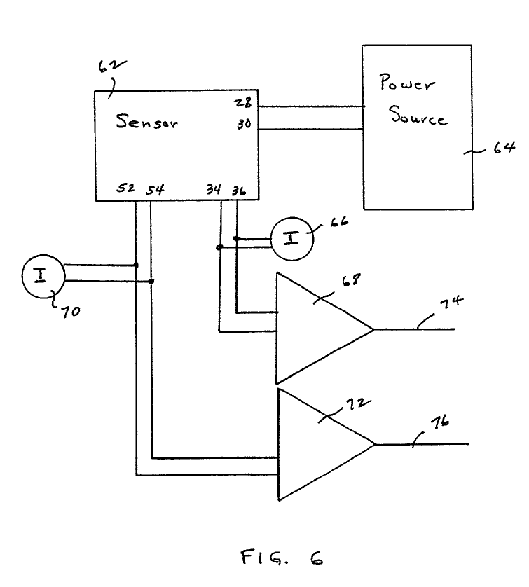

The graph of FIG. 7 exemplifies a calibration of the sensor for both temperature and gas concentration measurements in air (Oxygen at a fixed concentration) based on a plurality of environmental temperatures, like ambient A, 100° C., 150° C., 200° C., and 250° C., for example. In FIG. 7, the dots of the dashed line 80 represent the gas concentration measurements (volts) indexed to the ordinate to the left and the dots of the dashed line 82 represent the temperature measurements (volts) indexed to the ordinate to the right. The abscissa indexes the plurality of environmental temperatures under which the aforementioned measurements are taken. For example, at ambient temperature A, a gas concentration measurement 84 and a temperature measurement 86 are taken. Like measurements are taken for each of the other environmental temperatures 100° C., 150° C., 200° C., and 250° C. for this example. Accordingly, a look-up table may be created from these measurements and stored in memory for access during operation or self-test of the semiconductor sensor.

In accordance with another aspect of the present invention, a method of self-testing the semiconductor chemical gas sensor comprises the steps of: applying power to the heating element 22 by the power source 64; obtaining a measurement over line 74 from the temperature sensing element 24 using the measurement device comprising current source 66 and amplifier circuit 68; adjusting the power source 64 until the obtained measurement at 74 reaches a desired measurement; obtaining a measurement over line 76 from the gas sensitive element 49,50 when the desired measurement at 74 is reached; and comparing the obtained measurement at 76 to a reference measurement. The aforementioned method may include the step of calibrating the semiconductor sensor for a plurality of predetermined environment temperatures to determine reference measurements from the gas sensitive element 49,50 and temperature sensing element 24 at each predetermined environment temperature of said plurality as described herein above in connection with FIG. 7. After the sensor is calibrated, the power applied to the heating element 22 is adjusted to obtain each of the reference measurements (see line 82 of FIG. 7, for example) from the temperature sensing element 24 and the measurement from the gas sensitive element 49,50 is obtained for each of these temperature reference measurements. Then, the obtained measurements from the gas sensitive element may be compared with the respectively corresponding reference measurements from the gas sensitive element (see line 80 of FIG. 7, for example) to determine if the sensor is operating properly. This self-test method may be performed at ambient environmental temperatures and/or in air.

An alternate method of self-testing the semiconductor chemical gas sensor comprises the steps of: applying power to the heating element 22 using the power source 64; obtaining measurements from the gas sensitive element (line 76) and the temperature sensing element (line 74); adjusting the power source 64 to cause a change in the obtained measurement at 74; obtaining a change in measurement at 76 caused by the power adjustment; and determining if the obtained change in measurement at 76 is consistent with the change in the obtained measurement at 74. This method may include the steps of measuring the time over which the change in measurement from the gas sensitive element occurred; and determining if the measured time is consistent with proper operation of the sensor. The self-test method may also be performed at ambient environmental temperature and/or in air.

In this manner, a semiconductor sensor of the foregoing described type may be self-tested in situ for detection of degraded sensor operation as a result of contamination, instability or drift, for example. Therefore, the foregoing described methods provide for testing the reliability and integrity of the sensor in situ which will allow for an early detection of a potential degradation in sensor operation without having to remove the sensor from its operating environment.

While aspects of the present invention have been described in connection with various embodiments herein above, it is understood these embodiments are described merely by way of example and that in no way, shape or form are any of these embodiments intended to limit the present invention. Rather, the present invention should be construed in breadth and broad scope in accordance with the recitation of the claims appended hereto.

What is claimed is:

1. Method of self-testing a semiconductor chemical gas sensor including a heating element, a gas sensitive element and an embedded temperature sensing element, said method comprising the steps of:
applying power to the heating element;
obtaining a measurement from the temperature sensing element;
adjusting the power applied to the heating element until the obtained measurement from the temperature sensing element reaches a desired measurement;
obtaining a measurement from the gas sensitive element when said desired measurement is reached; and
comparing the obtained measurement from the gas sensitive element to a reference measurement.

2. The method of claim 1 including the step of calibrating said sensor for a plurality of predetermined environment temperatures to determine reference measurements from the gas sensitive element and temperature sensing element at each said predetermined environment temperature of said plurality.

3. The method of claim 2 wherein the power applied to the heating element is adjusted to obtain each of the reference measurements from the temperature sensing element; wherein the measurement from the gas sensitive element is obtained for each of the reference measurements from the temperature sensing element; and wherein the obtained measurements from the gas sensitive element are compared with the respectively corresponding reference measurements from the gas sensitive element.

4. The method of claim 1 wherein the steps of the self-test are performed at ambient temperature.

5. The method of claim 1 wherein the steps of the self-test are performed in air.

6. Method of self-testing a semiconductor chemical gas sensor including a heating element, a gas sensitive element and an embedded temperature sensing element, said method comprising the steps of:
applying power to the heating element;
obtaining measurements from the gas sensitive element and the temperature sensing element;
adjusting the power applied to the heating element to cause a change in the obtained measurement from the temperature sensing element;
obtaining a change in measurement from the gas sensitive element caused by said power adjustment; and
determining if the obtained change in measurement from the gas sensitive element is consistent with the change in the obtained measurement from the temperature sensing element.

7. The method of claim 6 wherein the steps of the self-test are performed at ambient temperature.

8. The method of claim 6 wherein the steps of the self-test are performed in air.

9. The method of claim 6 including the steps of measuring the time over which the change in measurement from the gas sensitive element occurred; and determining if said measured time is consistent with proper operation of the sensor.

10. Method of operating a semiconductor chemical gas sensor including a heating element, a gas sensitive element and an embedded temperature sensing element, said method comprising the steps of:
calibrating said sensor for a plurality of predetermined gas concentrations at a plurality of predetermined environment temperatures to establish first reference data representative of a gas concentration vs. gas sensitive element measurement relationship for each said predetermined environment temperature of said plurality and second reference data representative of a environment temperature vs. temperature sensing element measurement relationship;
storing said first and second reference data in a memory;
applying power to the heating element;
obtaining a measurement from the temperature sensing element;
obtaining a measurement from the gas sensitive element; and
accessing said memory with said temperature sensing element and gas sensitive element measurements to determine a gas concentration based on said temperature sensing element and gas sensitive element measurements.

11. The method of claim 10 wherein the first and second reference data are stored in the memory in the form of a look-up table.
